(19) United States
(12) Patent Application Publication
(10) Pub. No.: US 2025/0062989 A1
(43) Pub. Date: Feb. 20, 2025

(54) IPv6 Domain Level Source Routing and Forwarding

(71) Applicant: HUAWEI TECHNOLOGIES CO., LTD., Shenzhen (CN)

(72) Inventor: Haoyu Song, Plano, TX (US)

(21) Appl. No.: 18/939,009

(22) Filed: Nov. 6, 2024

Related U.S. Application Data
(63) Continuation of application No. PCT/US2022/049553, filed on Nov. 10, 2022.
(60) Provisional application No. 63/340,219, filed on May 10, 2022.

(51) Int. Cl. H04L 45/745; H04L 45/02

(52) U.S. Cl. CPC H04L 45/745; H04L 45/04

(57) ABSTRACT

A mechanism operated by a network node in a current network domain is disclosed. The mechanism includes obtaining a packet in an internet protocol (IP) version six (IPv6) format. The packet contains a header comprising a domain identifier (ID) list field and a base IPv6 destination address field. A next domain ID is determined from the domain ID list field. A next domain interface IP address is determined based on the next domain ID. The next domain interface IP address is copied into the base IPv6 destination address field. The packet is forwarded to the next domain interface IP address in the base IPv6 destination address field.

### CROSS-REFERENCE TO RELATED APPLICATIONS

This is continuation of International Application No. PCT/US2022/049553 filed Nov. 10, 2022, entitled “IPv6 Domain Level Source Routing and Forwarding,” which claims the benefit of U.S. Provisional Patent No. 63/340,219 filed May 10, 2022, entitled “End-to-End Quality-of-Service by Domain-Level Routing and Forwarding,” both of which are incorporated herein by reference in their entirety.

### TECHNICAL FIELD

The present disclosure is generally related to network communications, and is specifically related to a domain based routing mechanism that can function as layer 3.5 in the Open Systems Interconnection (OSI) model and/or Internet Protocol (IP) version six (IPv6) protocol stack.

### BACKGROUND

IP allows for consistent communication across a wide range of networks controlled by different groups. For example, an IP packet may be communicated from a sender to a receiver over multiple different networks. Further, each of these networks generally treats packets in a relatively consistent manner. Because each network is controlled by a different entity, orchestrating specialized end-to-end service for a particular flow including a series of packets is problematic. For example, a network could offer to provide special services for a user, but the network has no control over other networks between the sender and receiver and hence can only guarantee such services for part of the path. Accordingly, when a packet is delivered late from an upstream network, the network is unable to meet communication obligations to the user. Likewise, the network may communicate packets promptly, but downstream networks are not under any obligation to comply with the network's agreement with the user. Accordingly, offering specialized end-to-end services to users is impractical.

### SUMMARY

The disclosed aspects/embodiments provide a mechanism of domain routing. Each domain, also known as an autonomous system (AS), is virtualized into a node with edge routers acting as virtual interfaces. In this way, quality of service (QOS) data can be saved for each node, which can allow different domains to work together to provide end to end QoS for packet flows. For example, domain level source routing (DLSR) can be used. In DLSR routing, an IPV6 packet includes an IPV6 header and an extended DLSR routing header. The IPV6 header includes a destination address and other IPv6 related fields. The extended DLSR header includes an original destination address and a domain identifier (ID) list that identifies domains the packet should traverse along a path from the source to the destination. Edge nodes in each AS also contain a domain entry table. The domain entry table includes domain IDs and interface addresses. For example, each domain ID in the domain entry table is correlated to the interface address for the corresponding domain. When the extended DLSR header is included in the packet, the original destination address is set to the IP address of the destination and the domain ID list is included to indicate the path across the domains. The domain ID list can be obtained from a controller during path setup. When the packet is received by an edge node of an AS, the edge node uses the domain ID list to determine the domain ID of the next domain. The edge node then uses the domain ID to look up the interface address of the domain from the domain entry table. The edge node then copies the interface address of the next domain to destination address in the IPV6 header. In this way, the destination address is changed at each domain to point to the next domain, resulting in DLSR. Further, the extended DLSR header may include a DLSR options type length value (TLV). QoS information at each domain can be stored in this TLV. This provides QoS information that can be used in making routing decisions between domains to support path level QoS without exposing private domain data to other domains controlled by other providers. In this manner, different providers controlling different networks can work together to provide QoS guarantees to an end user and/or route packets exclusively through domains that have agreed to cooperate to provide such QoS guarantees. When the packet is received in the destination domain, the original destination address is copied back into the destination address in the IPV6 header.

A first aspect relates to a method implemented by a network node in a current network domain, the method comprising: obtaining a packet in an internet protocol (IP) version six (IPv6) format, the packet containing a header comprising a domain identifier (ID) list field and a base IPv6 destination address field; determining a next domain ID from the domain ID list field; determining a next domain interface IP address based on the next domain ID; copying the next domain interface IP address into the base IPv6 destination address field; and forwarding the packet toward the next domain interface IP address in the base IPv6 destination address field.

Optionally, in any of the preceding aspects, another implementation of the aspect provides that the header further comprises a domains left field containing a pointer to the next domain ID in the domain ID list field, and wherein the method further comprises decrementing the pointer upon determining the next domain ID.

Optionally, in any of the preceding aspects, another implementation of the aspect provides that the header further comprises a routing type field set to indicate domain level source routing is used for the packet.

Optionally, in any of the preceding aspects, another implementation of the aspect provides that the header further comprises a first domain field containing a pointer to a first domain ID in the domain ID list field.

Optionally, in any of the preceding aspects, another implementation of the aspect provides that the domain ID list field contains a list of domain IDs for each domain along a path between a source of the packet and the destination of the packet.

Optionally, in any of the preceding aspects, another implementation of the aspect provides that the header further comprises an original destination address field containing an address of a destination of the packet.

Optionally, in any of the preceding aspects, another implementation of the aspect provides that a value of the base IPv6 destination address field is changed at each domain along a path between a source of the packet and the destination of the packet.

Optionally, in any of the preceding aspects, another implementation of the aspect provides that a value of the original destination address field is not changed along the path between the source of the packet and the destination of the packet.

Optionally, in any of the preceding aspects, another implementation of the aspect provides that the header further comprises a domain level source routing (DLSR) options type length value (TLV) containing quality of service (QOS) data for domains traversed by the packet.

Optionally, in any of the preceding aspects, another implementation of the aspect provides that the network node includes a domain entry table, wherein the domain entry table includes entries correlating domain IDs of domains to interface addresses of the domains, and wherein the next domain ID is used to determine the next domain interface IP address in the domain entry table.

Optionally, in any of the preceding aspects, another implementation of the aspect provides that the header includes an IPV6 header containing the base IPv6 destination address field and an extended DLSR routing header containing the domain ID list field, the domains left field, the routing type field, the first domain field, the original destination address field, and the DLSR options TLV.

Optionally, in any of the preceding aspects, another implementation of the aspect provides querying a controller to obtain a list of domain IDs for each domain along a path between a source of the packet and a destination of the packet; and including the list of domain IDs in the domain ID list field.

A second aspect relates to a method implemented by a network node in a current network domain, the method comprising: receiving a packet in an internet protocol (IP) version six (IPv6) format, the packet containing a header comprising a domain left field, an original destination address field, and a base IPv6 destination address field; determining a current network domain is a final domain on a path based on the domain left field; copying the original destination address into the base IPv6 destination address field; and forwarding the packet toward the original destination address in the base IPv6 destination address field.

Optionally, in any of the preceding aspects, another implementation of the aspect provides that the base IPv6 destination address field contains an IPV6 address of the network node prior to copying the original destination address into the base IPv6 destination address field.

Optionally, in any of the preceding aspects, another implementation of the aspect provides that the header further comprises a routing type field set to indicate domain level source routing is used for the packet.

Optionally, in any of the preceding aspects, another implementation of the aspect provides that the header further comprises a domain ID list field containing a list of domain IDs for each domain along a path between a source of the packet and a destination of the packet.

Optionally, in any of the preceding aspects, another implementation of the aspect provides that the header further comprises a first domain field containing a pointer to a first domain ID in the domain ID list field.

Optionally, in any of the preceding aspects, another implementation of the aspect provides that the header further comprises a domain level source routing (DLSR) options type length value (TLV) containing quality of service (QOS) data for domains traversed by the packet.

Optionally, in any of the preceding aspects, another implementation of the aspect provides that the header includes an IPV6 header containing the base IPv6 destination address field and an extended DLSR routing header containing the domain ID list field, the domains left field, the routing type field, the first domain field, the original destination address field, and the DLSR options TLV.

Optionally, in any of the preceding aspects, another implementation of the aspect provides removing the extended DLSR routing header from the packet prior to forwarding the packet.

A third aspect relates to a network node comprising: a processor, a receiver coupled to the processor, a memory coupled to the processor, and a transmitter coupled to the processor, wherein the processor, receiver, memory, and transmitter are configured to perform the method of any of the preceding aspects.

A fourth aspect relates to non-transitory computer readable medium comprising a computer program product for use by a router, the computer program product comprising computer executable instructions stored on the non-transitory computer readable medium such that when executed by a processor cause the router to perform the method of any of the preceding aspects.

A fifth aspect relates to a network device, comprising: a receiving means for obtaining a packet in an internet protocol (IP) version six (IPv6) format, the packet containing a header comprising a domain identifier (ID) list field and a base IPv6 destination address field; a processing means for determining a next domain ID from the domain ID list field; determining a next domain interface IP address based on the next domain ID; and copying the next domain interface IP address into the base IPv6 destination address field; and a transmitting means for forwarding the packet toward the next domain interface IP address in the base IPv6 destination address field.

Optionally, in any of the preceding aspects, another implementation of the aspect provides that the network device is further configured to perform the method of any of the preceding aspects.

A sixth aspect relates to network device, comprising: a receiving means for receiving a packet in an internet protocol (IP) version six (IPv6) format, the packet containing a header comprising a domain left field, an original destination address field, and a base IPv6 destination address field; a processing means for determining a current network domain is a final domain on a path based on the domain left field; and copying the original destination address into the base IPV6 destination address field; and a transmitting means for forwarding the packet toward the original destination address in the base IPv6 destination address field.

Optionally, in any of the preceding aspects, another implementation of the aspect provides that the network device is further configured to perform the method of any of the preceding aspects.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example IPv6 based network of different domains configured to support communications between a source and a destination.

FIG. 2 is a schematic diagram of an example packet configured to support domain routing.

FIG. 3 is a schematic diagram of an example IP protocol stack including a domain routing layer.

FIG. 4 is a schematic diagram of an example domain entry table.

FIG. 5 is a protocol diagram of an example communication employing domain routing.

FIG. 6 is a schematic diagram of an example network element.

FIG. 7 is a flowchart of an example method of performing domain routing.

FIG. 8 is a flowchart of another example method of performing domain routing.

FIG. 9 is a schematic diagram of an example system for communicating data using domain routing.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a mechanism of domain routing. Each domain, also known as an autonomous system (AS), is virtualized into a node with edge routers acting as virtual interfaces. In this way, quality of service (QOS) data can be saved for each node, which can allow different domains to work together to provide end to end QoS for packet flows. For example, domain level source routing (DLSR) can be used. In DLSR routing, an IPV6 packet includes an IPV6 header and an extended DLSR routing header. The IPV6 header includes a destination address and other IPv6 related fields. The extended DLSR header includes an original destination address and a domain identifier (ID) list that identifies domains the packet should traverse along a path from the source to the destination. Edge nodes in each AS also contain a domain entry table. The domain entry table includes domain IDs and interface addresses. For example, each domain ID in the domain entry table is correlated to the interface address for the corresponding domain. When the extended DLSR header is included in the packet, the original destination address is set to the IP address of the destination and the domain ID list is included to indicate the path across the domains. The domain ID list can be obtained from a controller during path setup. When the packet is received by an edge node of an AS, the edge node uses the domain ID list to determine the domain ID of the next domain. The edge node then uses the domain ID to look up the interface address of the domain from the domain entry table. The edge node then copies the interface address of the next domain to destination address in the IPV6 header. In this way, the destination address is changed at each domain to point to the next domain, resulting in DLSR. Further, the extended DLSR header may include a DLSR options type length value (TLV). QoS information at each domain can be stored in this TLV. This provides QoS information that can be used in making routing decisions between domains to support path level QoS without exposing private domain data to other domains controlled by other providers. In this manner, different providers controlling different networks can work together to provide QoS guarantees to an end user and/or route packets exclusively through domains that have agreed to cooperate to provide such QoS guarantees. When the packet is received in the destination domain, the original destination address is copied back into the destination address in the IPV6 header.

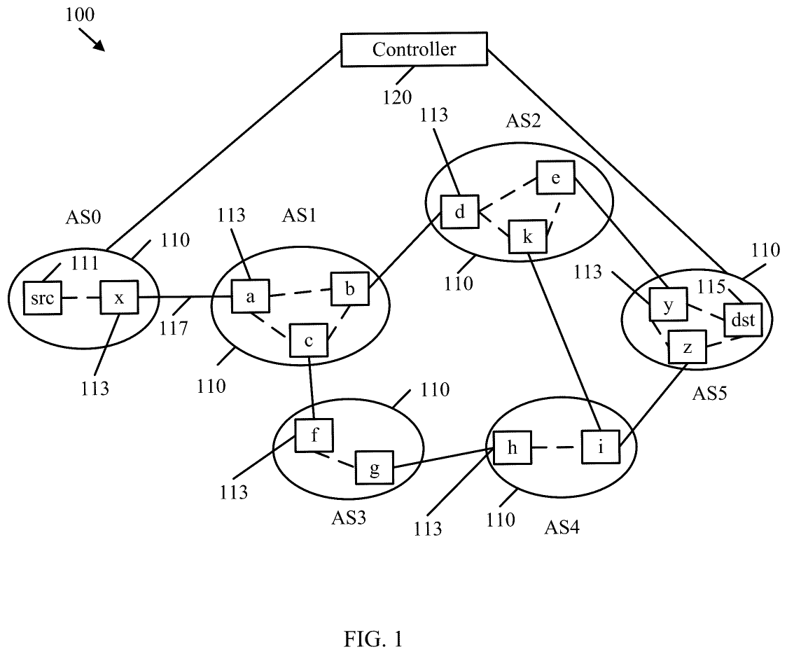

FIG. 1 is a schematic diagram of an example IPv6 based network 100 of different domains configured to support communications between a source 111 and a destination 115. The network 100 comprises a plurality of autonomous systems 110 configured to communicate via IP protocols. Each of the autonomous systems 110 is a group of interconnected network devices that form a domain. Hence, the term domain and autonomous system 110 can generally be used interchangeably herein. A domain is a realm of administrative autonomy, authority, or control within the Internet. Accordingly, each autonomous system 110 is generally controlled by a different entity. For security reasons, autonomous systems 110 generally do not share detailed information related to internal structure and operation. Each autonomous system 110 comprises edge nodes 113 and internal nodes (not shown). The internal nodes are configured to communicate data between the edge nodes 113. The edge nodes 113 serve as entry and exit points into the autonomous system 110 and the corresponding domain. The edge nodes 113 are configured to communicate flows of packets from a current autonomous system 110 to any other autonomous system 110 to which the edge node 113 is connected. The edge nodes 113 are further configured to provide security and other services to maintain the proper functionality of the corresponding autonomous system 110. Autonomous systems 110 that are connected can be referred to as adjacent. From the standpoint of a particular communication an autonomous system 110 in the direction of a source 111 is in an upstream direction, while an autonomous system 110 in the direction of a destination 115 is in a downstream direction.

The various nodes in the network 100 are connected by links 117. The inter-domain links are depicted as solid lines. The intra-domain links are depicted as dashed lines, and have been simplified by removing the connecting internal nodes for visual clarity. A link 117 is any connection between two points capable of communicating data, such as optical, electrical, electro-optical, and/or or wireless connections. A source 111 is any device configured to transmit packets of data in an IP format and a destination 115 is any device configured to receive packets from a source. For example, the source 111 and the destination 115 can be contained inside separate autonomous systems 110, as shown, when both devices are servers in data centers. In other examples, the source 111 and/or the destination 115 may be user devices contained outside a corresponding autonomous system 110.

In an example, the devices in network 100 communicate via IPv6. In IPV6, each device in the network 100 can be identified by a unique 128-bit address. In order to communicate data, such data is included in a payload portion of a packet. A packet header is appended to the front of the packet. Addresses of the source 111 and the destination 115 can be added to the packet header, and the packet can then be forwarded between nodes based on the information in the packet header. Packets can be organized into flows to allow for consistent communication of a larger amount of data between the source 111 and the destination 115. Flow labels indicating flow membership and other information used to describe packet handling can also be added to the headers of the packets.

An autonomous system 110 can offer a particular quality of service (QOS) to a source 111, such as maximum latency, minimum data throughput, maximum packet loss, a sufficient bit rate, a limited amount of jitter, and/or other handling metrics. However, each autonomous system 110 is typically controlled by a different entity than the other autonomous systems 110, and hence may be unable to guarantee that such QoS is honored by the other autonomous systems 110. For example, AS0 can guarantee QoS within AS0 (e.g., between the source 111 and the edge node x), but may be unable to guarantee such QoS outside AS0 (e.g., along a path from the edge node x to the destination 115) because the operators of AS0 do not control the operations of AS1, AS2, AS3, AS4, or AS5. Further, AS0 may even be unable to effectively communicate QoS requirements and/or status to the other autonomous systems 110. This is because IP protocols may focus on routing packet flows across a path between two points using the best route in a manner that does not consider the domains the path traverses. As such, the domains may be considered transparent to the IP protocol.

The present disclosure modifies IPv6 to provide domain level routing that considers the domains crossed by a packet. For example, QoS data related to particular autonomous systems 110 can be carried in an extended IPv6 header. This allows domains to alter packet handling behavior based on the current status of a packet. For example, a packet may be prioritized if the packet is projected to fall below a QoS guarantee. Further, packets can be routed around domains that have not agreed to provide QoS for the flow.

To perform domain level routing, each autonomous system 110 can be abstracted into a virtual router. Further, each edge node 113 can be abstracted into an interface into the corresponding virtual router. Such abstraction allows packets to be routed through particular domains via corresponding interfaces. Further, such abstraction allows the corresponding QoS information to be communicated in a manner that is abstract enough to hide security information while providing useful information for routing purposes.

Domain level routing may employ lookup tables at edge nodes 113. For example, an edge node 113 may contain a domain entry table. The domain entry table includes domain IDs and interface addresses. For example, each domain ID is correlated to the interface address for the corresponding domain. The edge nodes 113 are the interfaces to the autonomous systems 110, and hence each interface address is an IP address for an edge node an autonomous system 110. The entries in the domain entry table may vary from node to node.

The network 100 may also comprise a controller 120. The controller 120 includes one or more devices that have a global view of the network 100. The controller 120 may or may not be managed by the same entities that manage the autonomous systems 110. Accordingly, the controller 120 may have an abstracted view of the autonomous system 110. For example, the controller 120 may be aware of, and/or be able to determine via other communication protocols, the domains associated with the source 111 and the destination 115. Further the controller 120 is capable of determining a shortest distance and/or lowest cost domain level path between the source 111 and the destination 115 across the autonomous systems 110. For example, a source 111 and/or edge node 113 may send a request to the controller 120 to compute a path from the source 111 to the destination 115. The controller 120 can then compute the path and return, to the source 111, an ordered list of domain IDs for the autonomous systems 110 that perform a best path between the source 111 and the destination 115.

DLSR routing is an example routing mechanism that can be used to implement domain level routing. In DLSR, an IPV6 packet includes an IPV6 header and an extended DLSR routing header. In some examples, the source 111 may add the extended DLSR routing header to the packet. In other examples, the source 111 may forward packets toward the destination 115 using general IPv6 mechanisms and the first edge node along the path may add the extended DLSR routing header. The IPV6 header includes a destination address and other IPv6 related fields. The extended DLSR header includes an original destination address field and a domain ID list. The original address field and the IPv6 destination addresses may initially be set to the same value, in this example the IP address of the destination 115. The domain ID list is set to the ordered list of domain IDs creating a path between the source domain and the destination domain, for example as obtained from the controller 120.

In order to leave the domain, the packet is communicated to an edge node 113, for example edge node x, along the path from the source 111 to the destination 115. When the packet is received by edge node x, the edge node x uses the domain ID list to determine the domain ID of the next domain, in this case the domain ID for AS1. In some examples, the extended DLSR routing header may contain a pointer that points to the next domain ID in the domain ID list. The pointer can be incremented or decremented, depending on the list ordering, to a subsequent domain ID each time the next domain ID is determined by the current edge node. The edge node then uses the domain ID for AS1 to look up the interface address of AS1 from the domain entry table, in this case edge node a. The edge node x then copies the interface address of AS1 (e.g., the IPV6 address of edge node a) to destination address in the IPV6 header. This approach allows the network 100 to use the domain ID list to steer each packet to particular domains. Internal nodes may ignore the extended DLSR header, and may therefore route each packet based solely on the IPV6 destination address. Successive edge nodes 113 along the path may repeat this process as desired (e.g., upon entering and/or leaving a domain/AS). In this way, the destination address is changed at each domain to point to the next domain based on the domain ID list, which results in DLSR routing. For example, the internal nodes use the current value of the IPV6 destination address to route the packet through the domain, and the addresses from the domain ID list are used at the edge nodes to continue moving the packet downstream and toward the correct domain in the direction of the correct destination 115.

The packet is eventually received at the edge node 113 in the domain containing the destination 115, in this case edge node y in AS5. Edge node y is aware that the destination 115 is in its own domain. For example, edge node y may determine that the original address in the extended DLSR routing header uses a number in a range associated with AS5. In another example, the edge node y checks the pointer into the domain ID list and determine the pointer has reached a final value (e.g., has been decremented to zero and/or has reached the end of the list). Upon determining the packet is in the destination domain, the edge node y copies the original destination address back into the base IPv6 destination address field. The packet may then be forwarded to the destination 115 via IPv6 mechanisms. In some examples, the edge node 113 at the destination domain may also remove the extended DLSR routing header.

In some examples, the extended DLSR header may also include a DLSR options TLV. QOS information at each autonomous system 110 can be stored in this TLV. This provides QOS information at the domain level that can be used in making routing decisions between domains to support path level QoS. However, since the QoS information is an abstracted number that describes the general QoS status of the packet with respect to a domain, the QoS information does not expose private domain data to other domains controlled by other providers. In this manner, different providers controlling different autonomous networks 110 can work together to provide QoS guarantees to an end user and/or route packets exclusively through domains that have agreed to cooperate to provide such QoS guarantees. In an example, the domain based routing described herein can be used to support cross-domain virtual private paths, deadline based forwarding, and/or service function chaining.

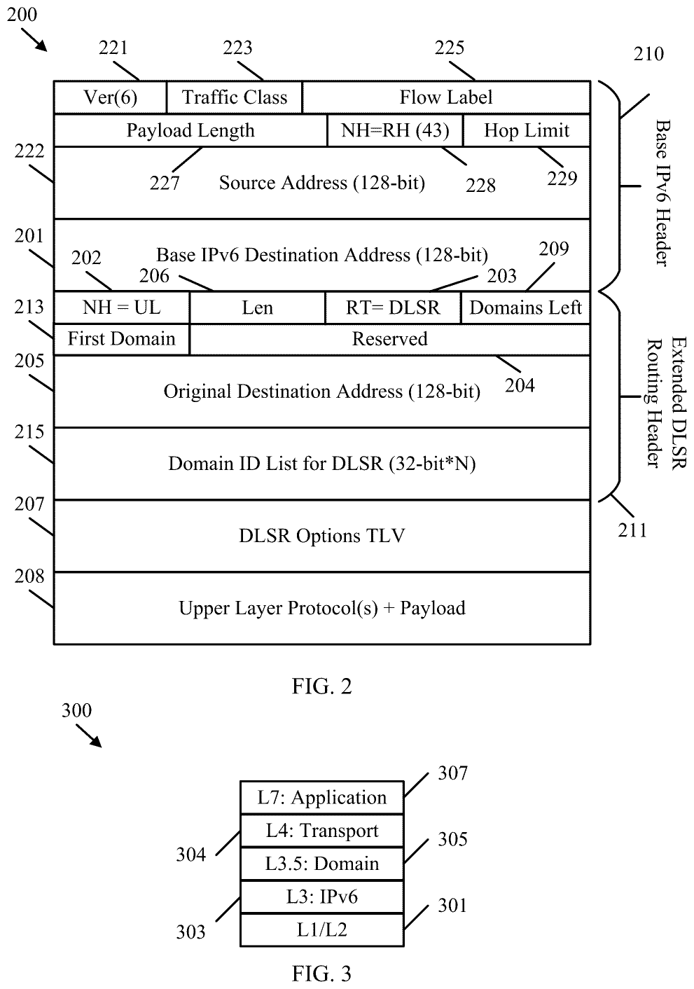

FIG. 2 is a schematic diagram of an example packet 200 configured to support domain routing, for example in network 100. The packet 200 includes a base IPv6 header 210, an extended DLSR routing header 211, and a payload for transporting data and/or information related to upper layer protocols. The base IPv6 header 210 includes fields used for IPV6 routing. Such fields may include a version field 221 set to indicate the packet is an IPV6 packet, a traffic class field 223 containing packet priority information, a flow label field 225 containing a flow label to indicate an association between the packet and a flow, a payload length field 227 set to indicate the number of bits in the payload, a next header field 228 that indicates the next header is a routing header, a hop limit field 229 indicating a number of hops a packet can traverse before being considered stale, and a source address field 222 indicating the IP address of the packet source etc. The base IPv6 header 210 also contains a destination address 201, which contains the destination address of the packet. The destination address 201 is a 128-bit address in IPV6 format. The destination address 201 indicates the address of the destination for the packet. As noted above, the destination address may instead indicate the IP address of the edge node of the next domain along a path to the destination when the packet is routed according to domain level routing. The destination address 201 may also be referred to as the IPV6 destination address to contrast with an original destination address 205.

The extended DLSR routing header 211 includes various fields to support domain level routing. The first eight octets of the extended DLSR routing header 211 include a next header field 202, a length field 206, a routing type 203, and reserved bits 204 which are reserved for other purposes. The next header field 202 indicates the next extension header following the current header, in this case an upper layer header 208 used by upper layer protocols followed by the packet payload. It should be noted that other extension headers may be included after the extended DLSR routing header 211, in which case the next header field 202 indicates the type of the next header. The length field 206 indicates the length of the extended DLSR routing header 211. The routing type 203 contains data indicating the type of routing used for the packet. In the present example, the routing type 203 is set to a value indicating DLSR routing is employed for the current packet.

The extended DLSR routing header 211 further comprises an original destination address 205 and a DLSR options TLV 207. The original destination address 205 is a 128-bit address in IPV6 format. The original destination address 205 indicates the IP address of the actual destination address for the packet. As noted above, the original destination address 205 can be copied back into the destination address 201 once the packet 100 has reached the destination domain containing the destination indicated by the original destination address 205. The DLSR options TLV 207 may contain any QoS data related to the one or more domains traversed by the packet and/or any QoS requirements related to the packet. The DLSR options TLV 207 is optional.

The extended DLSR routing header 211 further comprises a domain ID list 215, a domains left 209, and a first domain 213. The domain ID list 215 is a field containing an ordered list of each domain ID on a domain level path between the source and the destination for use in DLSR. The domain ID list 215 may be 32*N bits long, where N is the number of domains along the path between the source and destination domains. In the present example, the domain IDs are included in reverse order with the destination domain ID positioned in the first entry of the domain ID list 215 and the source domain ID positioned in the last entry of the domain ID list 215. The domains left 209 is a field containing a pointer to the next domain ID in the domain ID list 215. The domains left 209 may be eight bits long. The first domain 213 is a field containing a pointer to the last domain ID in the domain ID list 215, and hence points to the ID for the source domain. The first domain 213 may be eight bits long.

For example, upon generation of the extended DLSR routing header 211, the domains left 209 is set to point to the last entry of the domain ID list 215 minus one. Hence, the domains left 209 initially points to the next domain ID along the domain path after the source domain. When an edge node receives the packet, the edge node uses the domains left 209 to determine the next domain ID in the domain ID list 215. The edge node uses that next domain ID to determine the IP interface into the next domain via the domain entry table and copies the resulting IP address into the destination address 201 in the base IPv6 header 210. The edge node decrements the pointer in the domains left 209 so a subsequent edge node can repeat the process. When the destination domain is reached, the destination edge node can determine that the domains left 209 no longer points to a valid entry, and hence there are no more domains to traverse. The destination edge node can then copy the original destination address 205 into the destination address 201 in the Base IPv6 header 210. The destination edge node can optionally remove the extended DLSR routing header 211 and can forward the packet toward the destination using the base IPv6 header 210.

FIG. 3 is a schematic diagram of an example IP protocol stack 300 including a domain routing layer. The IP protocol stack 300 may be substantially similar to the Open Systems Interconnection (OSI) model. The IP protocol stack 300 includes layer 1/layer 2 forwarding 301, layer 3 routing using IPv6 303, layer 4 transport 304 routing, and layer 7 application 307 based communications. As shown, the present disclosure adds a layer 3.5, which includes domain level routing 305. Domain level routing 305 includes routing packets between domains. Such routing abstracts domains, and hence may not consider all hops along a path as such functions are managed by layer 3. Further, domain level routing 305 may not consider transport-based concerns such as connections as such concepts are managed by layer 4. Layer 3.5 may be used to make domain and/or AS routing explicit and visible to both end hosts and service providers. This results in a service level that is measurable. Further, service providers can be held responsible for managing such traffic, which may support mechanisms for cooperation for providing end to end QoS. The usage of layer 3.5 also brings domain visibility to the forwarding plane. In addition, the usage of layer 3.5 also creates an overlay, which hides underlay details and supports usage of many types of layer 3 protocols.

FIG. 4 is a schematic diagram of an example domain entry table 400. The domain entry table 400 is a lookup table configured to store domain IDs 401 and correlate them with interface addresses 403 indicating IPv6 addresses of edge nodes that act as interface nodes into the indicated domain. A domain entry table 400 can be stored at each edge node, such as edge nodes 113 in network 100. The domain IDs 401 of the domain entry table 400 correlate to the domain IDs in the domain ID list 215. Accordingly, the edge node processing a packet can use the next domain ID from the domain ID list 215 as a domain ID 401 used as input into the domain entry table 400. As such, the domain entry table 400 can be used to determine the IP address that should be used to access a next domain. Hence, an edge node can use the interface address 403 as a next hop from a domain routing perspective. Further, the edge node can include the interface address 403 in the base IPv6 destination address field in the IPV6 base header as discussed above.

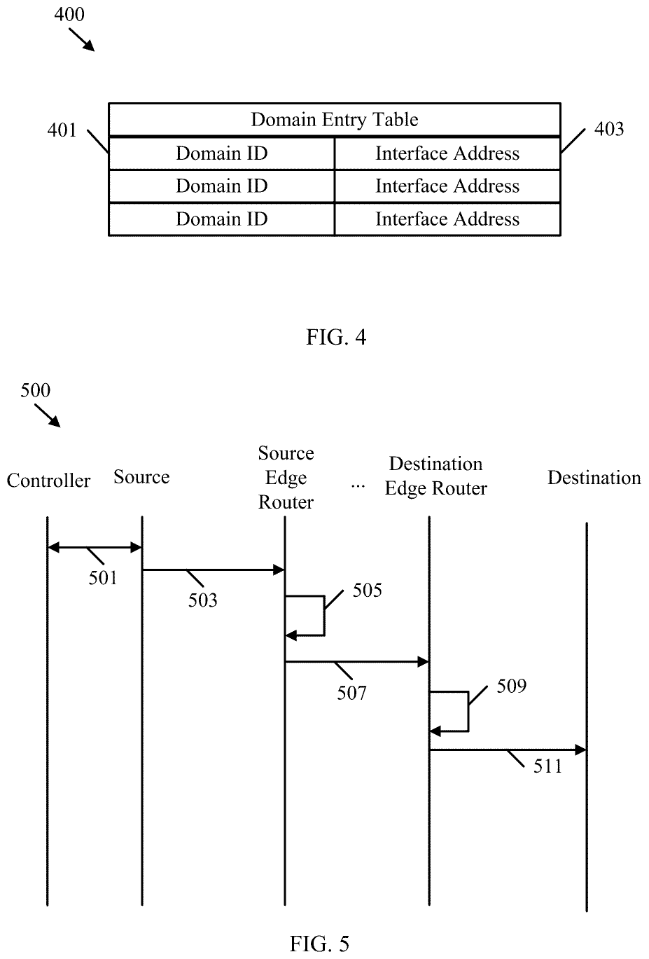

FIG. 5 is a protocol diagram of an example communication 500 employing domain routing, such as DLSR routing, as described above. At step 501, a source communicates with a controller to request and receive a domain level path between the source and the destination. At step 503, the source generates a packet. The packet at step 503 is generated as an IPV6 packet with an extended DLSR routing header. The source sets the original destination address field in the extended DLSR routing header as the IP address of the destination. The source also sets the domain ID list to include the domain level path from the controller, sets the routing type to DLSR, and sets the domains left and first domain pointers into the corresponding entries in the domain ID list. The source may also add a DLSR options TLV with relevant QoS information to the extended DLSR routing header. The source sets the source and destination addresses in the base IPv6 headers and transmits the packet. The packet is directed toward an edge router in the source domain, denoted as a source edge router for clarity of discussion.

In some examples, the source may instead transmit an IPV6 packet toward the source edge router at step 503, and the source edge router may perform step 501 to obtain the domain level path from the controller. In such a case, the source edge router adds the extended DLSR routing header to the IPv6 packet as discussed above.

In either case, the source edge router processes the IPV6 packet with the extended DLSR routing header at step 505. At step 505, the source edge router uses the pointer indicated in the domains left field to locate the domain ID of the next domain from the domain ID list. The source edge router then uses the domain ID to look up an interface address for the next domain from the domain entry table. The source edge router then sets the IPv6 destination address in the base IPv6 header to the interface address for the next domain. The source edge router may also decrement the value in the domains left field so that the pointer continues to point to the next domain when received by an edge router in a subsequent domain along the path.

At step 507, the source edge router sends the packet toward the next domain in the direction of the destination based on the IPV6 destination address. At each domain along the path, an edge router performs step 505 based on the domains left field, the domain ID list, and a local domain entry table. This process continues until the packet is received at the edge router at the destination domain, denoted as the destination edge router for clarity of discussion. In this way, the original destination address does not change, but the IPV6 destination address changes at each domain resulting in domain layer routing.

At step 509, the destination edge router determines the destination address is in the same domain as the destination edge router. This can be accomplished by determining the original destination address value is in a range associated with the destination domain. In another example, the destination edge router can determine that the domains left field no longer points to a valid entry in the domain ID list. Once the destination edge router determines the destination address is in the current domain, the destination router copies the original destination address into the IPV6 destination address in the base IPv6 header. The destination edge router may also optionally remove the extended DLSR routing header at step 509. At step 511, the destination edge router forwards the packet toward the destination using layer three IPv6 routing mechanisms.

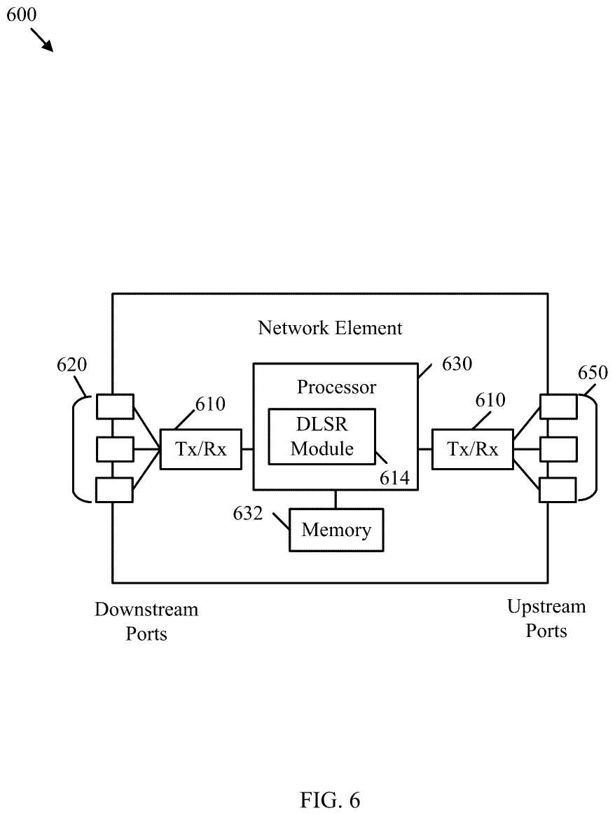

FIG. 6 is a schematic diagram of an example network element 600. The network element 600 is suitable for implementing the disclosed examples/embodiments as described herein. The network element 600 comprises downstream ports 620, upstream ports 650, and/or transceiver units (Tx/Rx) 610, including transmitters and/or receivers for communicating data upstream and/or downstream over a network. The network element 600 also includes a processor 630 including a logic unit and/or central processing unit (CPU) to process the data and a memory 632 for storing the data. The network element 600 may also comprise electrical, optical-to-electrical (OE) components, electrical-to-optical (EO) components, and/or wireless communication components coupled to the upstream ports 650 and/or downstream ports 620 for communication of data via electrical, optical, or wireless communication networks. The network element 600 may also include input and/or output (I/O) devices for communicating data to and from a user. The I/O devices may include output devices such as a display for displaying image and/or video data. The I/O devices may also include input devices, such as a keyboard, mouse, trackball, etc., and/or corresponding interfaces for interacting with such output devices.

The processor 630 is implemented by hardware and software. The processor 630 may be implemented as one or more CPU chips, cores (e.g., as a multi-core processor), field-programmable gate arrays (FPGAs), application specific integrated circuits (AS1Cs), and digital signal processors (DSPs). The processor 630 is in communication with the downstream ports 620, Tx/Rx 610, upstream ports 650, and memory 632. The processor 630 comprises a DLSR module 614. The DLSR module 614 implements the disclosed embodiments described herein. For example, the DLSR module 614 may route a packet 200 according to DLSR routing by using a domain ID list and a domain entry table 400, for example as described with respect to communication 500. As such, the DLSR module 614 improves the functionality of the network element 600 as well as addresses problems that are specific to the image coding arts. Further, the DLSR module 614 affects a transformation of the network element 600 to a different state. Alternatively, the DLSR module 614 can be implemented as instructions stored in the memory 632 and executed by the processor 630 (e.g., as a computer program product stored on a non-transitory medium).

The memory 632 comprises one or more memory types such as disks, tape drives, solid-state drives, read only memory (ROM), random access memory (RAM), flash memory, ternary content-addressable memory (TCAM), static random-access memory (SRAM), etc. The memory 632 may be used as an over-flow data storage device, to store programs when such programs are selected for execution, and to store instructions and data that are read during program execution.

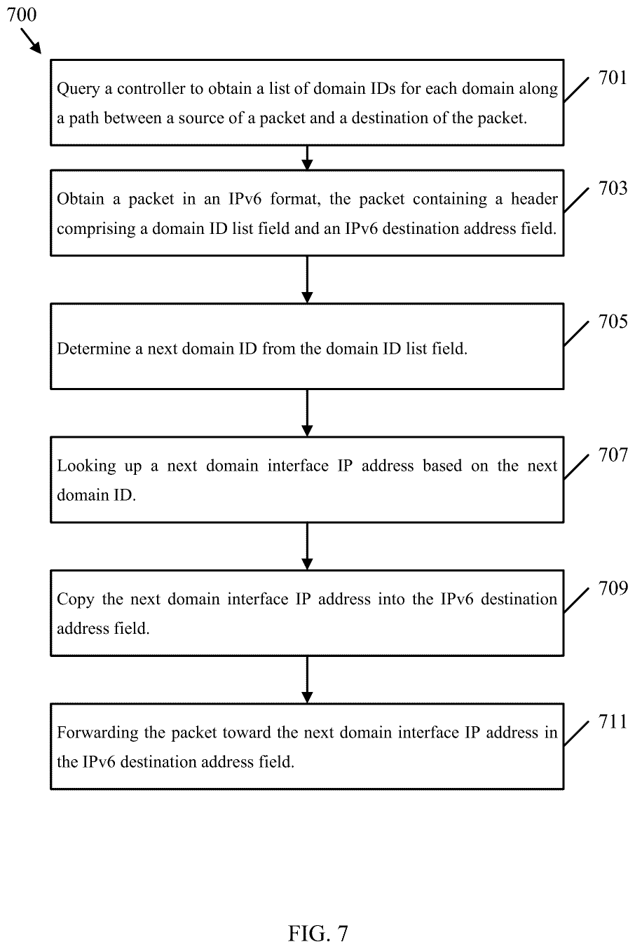

FIG. 7 is a flowchart of an example method 700 of performing domain routing. For example, the method 700 can be performed in a source, a source edge node in a source domain, and/or an edge node in a domain along a path as described with respect to network 100. The method 700 can be applied to a packet such as packet 200. The method 700 can employ a domain entry table 400. Further, the method 700 can be employed to perform steps in communication 500. In addition, method 700 can be implemented in a network element 600. The method 700 is performed by a network node positioned in a current network domain.

At step 701, the network node optionally queries a controller to obtain a list of domain IDs for each domain along a path between a source of the packet and a destination of the packet.

At step 703, the network node obtains a packet in an IPV6 format. The packet contains a header comprising a domain ID list field and a base IPv6 destination address field. When the network node queries the controller at step 701, the network node includes the list of domain IDs in the domain ID list field at step 703. The domain ID list field may contain a list of domain IDs for each domain along a path between a source of the packet and the destination of the packet. The header may further comprise a routing type field set to indicate domain level source routing is used for the packet. The header may further comprise a first domain field containing a pointer to a first domain ID in the domain ID list field. The header may further comprise an original destination address field containing an address of a destination of the packet. The header may further comprise a DLSR options TLV containing QoS data for domains traversed by the packet. In an example, the header includes an IPV6 header containing the base IPv6 destination address field and an extended DLSR routing header containing the domain ID list field, a domains left field, the routing type field, the first domain field, the original destination address field, and the DLSR options TLV.

At step 705, the network node determines a next domain ID from the domain ID list field. For example, the header may further comprise a domains left field containing a pointer to the next domain ID in the domain ID list field. The network node may use the pointer to determine the next domain ID and decrement the pointer upon determining the next domain ID.

At step 707, the network node determines, via a table, a next domain interface IP address based on the next domain ID. For example, the network node may include a domain entry table. The domain entry table includes entries correlating domain IDs of domains to interface addresses of domains. As such, the next domain ID can be used to determine the next domain interface IP address in the domain entry table.

At step 709, the network node copies the next domain interface IP address into the base IPv6 destination address field. In this way, a value of the base IPv6 destination address field is changed at each domain along a path between a source of the packet and the destination of the packet. However, a value of the original destination address field is not changed along the path between the source of the packet and the destination of the packet.

At step 711, the network node forwards the packet toward the next domain interface IP address in the base IPv6 destination address field.

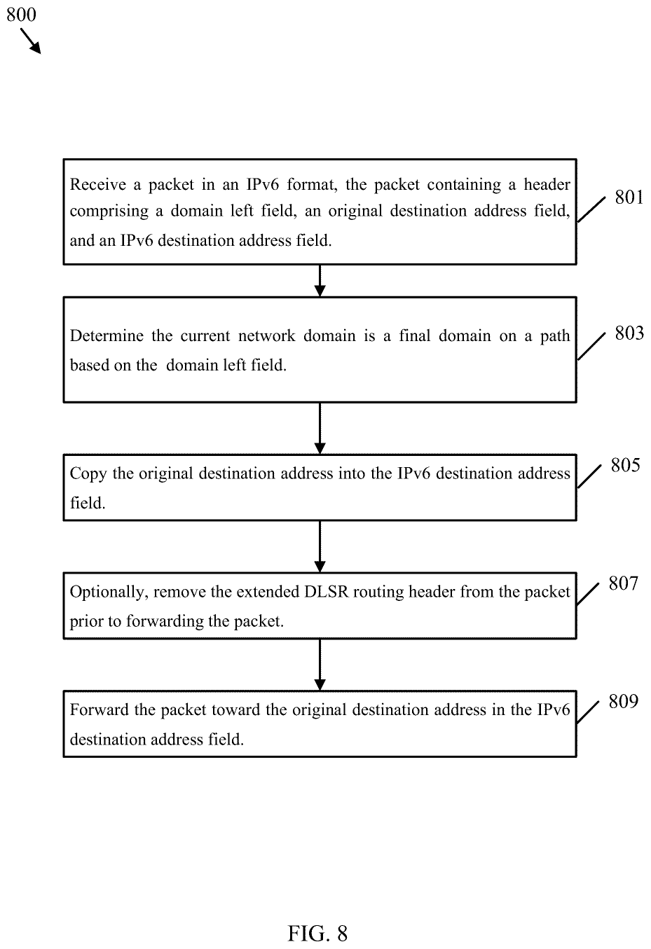

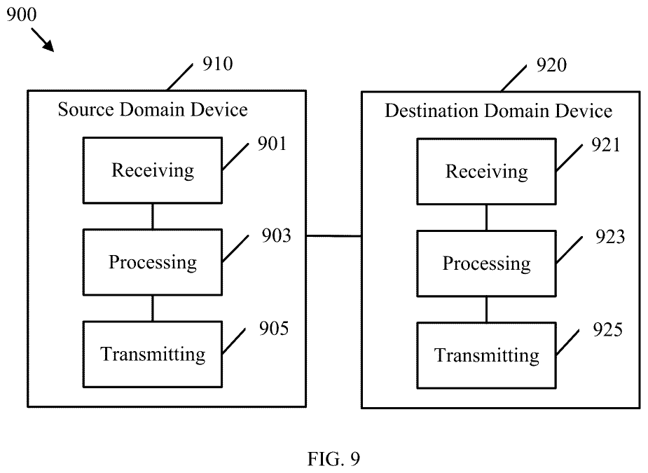

FIG. 8 is a flowchart of another example method 800 of performing domain routing. For example, the method 800 can be performed in an edge node in a domain, such as a destination edge node in a destination domain as described with respect to network 100. The method 800 can be applied to a packet such as packet 200. The method 800 can employ a domain entry table 400. Further, the method 800 can be employed to perform steps in communication 500. In addition, method 800 can be implemented in a network element 600. The method 800 is performed by a network node positioned in a current network domain.

At step 801, the network node receives a packet in an IPV6 format. The packet contains a header comprising a domain left field, an original destination address field, and a base IPv6 destination address field. In an example, the header further comprises a routing type field set to indicate domain level source routing is used for the packet. In an example, the header further comprises a domain ID list field containing a list of domain IDs for each domain along a path between a source of the packet and a destination of the packet. In an example, the header further comprises a first domain field containing a pointer to a first domain ID in the domain ID list field. In an example, the header further comprises a DLSR options TLV containing QoS data for domains traversed by the packet. In an example, the header includes an IPV6 header containing the base IPv6 destination address field and an extended DLSR routing header containing the domain ID list field, the domains left field, the routing type field, the first domain field, the original destination address field, and the DLSR options TLV.

At step 803, the network node determines a current network domain is a final domain on a path based on the domain left field.

At step 805, the network node copies the original destination address into the base IPv6 destination address field. In an example, the base IPv6 destination address field contains an IPV6 address of the network node prior to copying the original destination address into the base IPv6 destination address field.

At step 807, the network node optionally removes the extended DLSR routing header from the packet prior to forwarding the packet.

At step 809, the network node forwards the packet toward the original destination address in the base IPv6 destination address field.

FIG. 9 is a schematic diagram of an example system 900 for communicating data using domain routing. The system 900 may employ a source domain device 910, which may be implemented by a source 111, an edge node 113, a network element 600, or combinations thereof. The system 900 may also comprise a destination domain device 920, which may be implemented by an edge node 113, a network element 600, or combinations thereof.

The source domain device 910 includes a receiving module 901 for obtaining a packet in an IPV6 format, the packet containing a header comprising a domain identifier (ID) list field and a base IPv6 destination address field. The source domain device 910 also includes a processing module 903 for determining a next domain ID from the domain ID list field; determine up a next domain interface IP address using the next domain ID; and copying the next domain interface IP address into the base IPv6 destination address field. The source domain device 910 also includes a transmitting module 905 for forwarding the packet toward the next domain interface IP address in the base IPv6 destination address field. The source domain device 910 may be further configured to perform any of the steps of method 700.

The destination domain device 920 includes a receiving module 921 for receiving a packet in an IPv6 format, the packet containing a header comprising a domain left field, an original destination address field, and a base IPv6 destination address field. The destination domain device 920 also includes a processing module 923 for determining the current network domain is a final domain on a path based on the domain left field; and copying the original destination address into the base IPv6 destination address field. The destination domain device 920 also includes a transmitting module 925 for forwarding the packet toward the original destination address in the base IPv6 destination address field. The destination domain device 920 may be further configured to perform any of the steps of method 800.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

It should also be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method implemented by a network node in a current network domain, the method comprising:
obtaining a packet in an internet protocol (IP) version six (IPv6) format, the packet containing a header comprising a domain identifier (ID) list field and a base IPv6 destination address field;
determining a next domain ID from the domain ID list field;
determining a next domain interface IP address based on the next domain ID;
copying the next domain interface IP address into the base IPv6 destination address field; and
forwarding the packet toward the next domain interface IP address in the base IPv6 destination address field.

2. The method of claim 1, wherein the header further comprises a domains left field containing a pointer to the next domain ID in the domain ID list field, and wherein the method further comprises decrementing the pointer upon determining the next domain ID.

3. The method of claim 1, wherein the header further comprises a routing type field set to indicate domain level source routing is used for the packet.

4. The method of claim 1, wherein the header further comprises a first domain field containing a pointer to a first domain ID in the domain ID list field.

5. The method of claim 1, wherein the domain ID list field contains a list of domain IDs for each domain along a path between a source of the packet and a destination of the packet.

6. The method of claim 1, wherein the header further comprises an original destination address field containing an address of a destination of the packet.

7. The method of claim 1, wherein a value of the base IPv6 destination address field is changed at each domain along a path between a source of the packet and a destination of the packet.

8. The method of claim 7, wherein a value of an original destination address field is not changed along the path between the source of the packet and the destination of the packet.

9. The method of claim 1, wherein the header further comprises a domain level source routing (DLSR) options type length value (TLV) containing quality of service (QOS) data for domains traversed by the packet.

10. The method of claim 1, wherein the network node includes a domain entry table, wherein the domain entry table includes entries correlating domain IDs of domains to interface addresses of the domains, and wherein the next domain ID is used to determine the next domain interface IP address in the domain entry table.

11. The method of claim 1, wherein the header includes an IPV6 header containing the base IPv6 destination address field and an extended domain level source routing (DLSR) header containing the domain ID list field, a domains left field, a routing type field, a first domain field, an original destination address field, and a DLSR options type length value (TLV).

12. The method of claim 1, further comprising:
querying a controller to obtain a list of domain IDs for each domain along a path between a source of the packet and a destination of the packet; and
including the list of domain IDs in the domain ID list field.

13. A method implemented by a network node in a current network domain, the method comprising:
receiving a packet in an internet protocol (IP) version six (IPv6) format, the packet containing a header comprising a domains left field, an original destination address field, and a base IPv6 destination address field;
determining a current network domain is a final domain on a path based on the domains left field;
copying an original destination address into the base IPv6 destination address field; and
forwarding the packet toward the original destination address in the base IPv6 destination address field.

14. The method of claim 13, wherein the base IPv6 destination address field contains an IPv6 address of the network node prior to copying the original destination address into the base IPv6 destination address field.

15. The method of claim 13, wherein the header further comprises a routing type field set to indicate domain level source routing is used for the packet.

16. The method of claim 13, wherein the header further comprises a domain ID list field containing a list of domain IDs for each domain along a path between a source of the packet and a destination of the packet.

17. The method of claim 16, wherein the header further comprises a first domain field containing a pointer to a first domain ID in the domain ID list field.

18. The method of claim 17, wherein the header further comprises a domain level source routing (DLSR) options type length value (TLV) containing quality of service (QOS) data for domains traversed by the packet.

19. The method of claim 18, wherein the header includes an IPV6 header containing the base IPv6 destination address field and an extended DLSR routing header containing the domain ID list field, a domains left field, a routing type field, a first domain field, the original destination address field, and the DLSR options TLV.

20. A network node comprising:
a processor;
a transmitter coupled to the processor;
a receiver coupled to the processor; and
a memory coupled to the processor and storing instructions that when executed by the processor cause the network node to:
receive a packet in an internet protocol (IP) version six (IPv6) format, the packet containing a header comprising a domains left field, an original destination address field, and a base IPv6 destination address field;
determine a current network domain is a final domain on a path based on the domains left field; and copying an original destination address into the base IPv6 destination address field; and
forward the packet toward the original destination address in the base IPv6 destination address field.
